(19) United States
(12) Patent Application Publication
(10) Pub. No.: US 2019/0146431 A1
(43) Pub. Date: May 16, 2019

(54) BUILDING MANAGEMENT SYSTEM WITH GEOLOCATION-BASED FAULT NOTIFICATIONS

(71) Applicant: Johnson Controls Technology Company, Auburn Hills, MI (US)

(72) Inventors: Rajesh C. Nayak, Vidyaratna Nagar Manipal (IN); Barkha Shah, West Mumbai (IN); Jayesh Shirish Patil, West Mumbai (IN); Dilip Divila Raju, Bhurahan Puram (IN); Ashok Sridharan, Woraiyur Tiruchirappalli (IN); Satish Pandhari Vaidya, Andheri (IN)

(73) Assignee: Johnson Controls Technology Company, Auburn Hills, MI (US)

(21) Appl. No.: 16/052,115

(22) Filed: Aug. 1, 2018

(30) Foreign Application Priority Data
Nov. 15, 2017 (IN) 201741040780

(51) Int. Cl. G05B 15/02; F24F 11/52; F24F 11/32; G01S 19/51

(52) U.S. Cl. CPC G05B 15/02; G01S 19/51; F24F 11/32; F24F 11/52

(57) ABSTRACT

The building management system includes building equipment located in a plurality of locations and configured to provide data relating to operation of the building equipment and a fault notification system. The fault notification system is configured to collect the data from the building equipment, detect a fault in the operation of the building equipment based on the data, identify a fault location of the fault from the plurality of locations, identify a user location of the user from the plurality of locations, determine whether the user location matches the fault location, and in response to a determination that the user location matches the fault location, provide a graphical user interface to a user. The graphical user interface identifies the fault.

### CROSS-REFERENCE TO RELATED PATENT APPLICATION

This application claims the benefit of and priority to Indian Patent Application No. 201741040780 filed Nov. 15, 2017, incorporated by reference herein in its entirety.

### BACKGROUND

The present disclosure relates generally to a building management system (BMS) and more particularly to a BMS with geolocation-based fault notifications. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

In a BMS, a fault notification system provides alerts and information to a user related to building equipment which are not functioning as expected, meters which are reporting points outside an expected range, or other data points which indicate some aspect of the BMS is in a fault condition. Traditionally, alerts and reported information may be organized chronologically, such that the most recent faults appear first on a fault notification interface, or may be organized by priority level or criticality. When the BMS components are located in many buildings or facilities across multiple geographic locations, a user may have difficulty in identifying the faults from the user's current location.

### SUMMARY

One implementation of the present disclosure is a building management system. The building management system includes building equipment located in a plurality of locations and configured to provide data relating to operation of the building equipment and a fault notification system. The fault notification system is configured to collect the data from the building equipment, detect a fault in the operation of the building equipment based on the data, identify a fault location of the fault from the plurality of locations, identify a user location of the user from the plurality of locations, determine whether the user location matches the fault location, and in response to a determination that the user location matches the fault location, provide a graphical user interface to a user. The graphical user interface identifies the fault.

In some embodiments, the fault notification system is configured to prevent the user from accessing information about the fault in response to a determination that the user location does not match the fault location.

In some embodiments, the fault notification system is configured to verify the user location by receiving GPS coordinates of a user device from the user device receiving an IP address of the user device accessing a look-up table that associates a set of IP addresses with the GPS coordinates of the user device and determining whether the IP address of the user device is included in the set of IP addresses with the GPS coordinates of the user device.

In some embodiments, the fault notification system is configured to generate a fault data object for the detected fault and include the fault location as an attribute of the fault data object. In some embodiments, the fault notification system is configured to receive consent from the user to use a location of the user device and cause a GPS chip of the user device to activate and provide the GPS coordinates to the fault notification system in response to receiving the consent from the user.

Another implementation of the present disclosure is a method for managing and controlling building equipment. The method includes operating building equipment to provide data relating to operation of the building equipment. The building equipment is located in a plurality of locations. The method also includes detecting a fault in the operation of the building equipment based on the data, identifying a fault location of the fault from the plurality of locations identifying a user location of the user from the plurality of locations, determining whether the user location matches the fault location, and in response to a determination that the user location matches the fault location, providing a graphical user interface to a user. The graphical user interface provides information relating to the fault.

In some embodiments, the method includes preventing the user from accessing information about the fault in response to a determination that the user location does not match the fault location.

In some embodiments, the method also includes verifying the user location by receiving GPS coordinates of a user device from the user device, receiving an IP address of the user device, accessing a look-up table that associates a set of IP addresses with the GPS coordinates of the user device, and determining whether the IP address of the user device is included in the set of IP addresses with the GPS coordinates of the user device.

In some embodiments, the method includes determining whether the user is authorized to access fault notifications for the fault location. In some embodiments, the method includes generating a fault data object for the detected fault and including the fault location as an attribute of the fault data object.

In some embodiments, identifying a user location of the user from the plurality of locations comprises receiving GPS coordinates of a user device from the user device and determining that the GPS coordinates of the user device are within a present distance of the GPS coordinates of a first location of the plurality of locations. In some embodiments, the method includes receiving consent from the user to use the location of the user device and causing a GPS chip of the user device to activate and provide the GPS coordinates in response to receiving the consent from the user.

Another implementation of the present disclosure is a building management system. The building management system includes building equipment located in a plurality of locations and configured to provide data relating to operation of the building equipment and a fault notification system. The fault notification system is configured to collect the data from the building equipment, detect a plurality of faults in the operation of the building equipment based on the data, identify, for each of the plurality of faults, a fault location from the plurality of locations, identify a user location of a user device from the plurality of locations by causing a GPS chip of the user device to activate and provide the user location to the fault notification circuit, identify a set of faults from the plurality of faults for which the fault location matches the user location, generate a graphical user interface that identifies each fault of the set of faults, and provide the graphical user interface to the user device.

In some embodiments, the graphical user interface includes a list of the faults from the set of faults. The list is organized based on a priority of each fault. In some embodiments, the graphical user interfaces includes a list of each of the plurality of faults. The set of faults for which the user location matches the fault location is positioned at a top of the list.

In some embodiments, the plurality of locations include a plurality of buildings and the building equipment is operable to affect variable states or conditions of the plurality of buildings. In some embodiments, the building equipment includes HVAC equipment. In some embodiments, the fault notification system is configured to receive a security token from the user device and, in response to receiving the security token, allow the user to access the graphical user interface.

### BRIEF DESCRIPTION OF THE DRAWINGS

FIG. 1 is a drawing of a building equipped with a HVAC system, according to some embodiments.

FIG. 2 is a block diagram of a waterside system which can be used to serve the building of FIG. 1, according to some embodiments.

FIG. 3 is a block diagram of an airside system which can be used to serve the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is a block diagram of an automated system for geolocation-based fault notification, which can be implemented as a component of the BMSs of FIGS. 4-5, according to some embodiments.

FIG. 7 is a flowchart of a method for presenting fault notifications based on a user's location, which can be performed by the BMSs of FIGS. 4-5, according to some embodiments.

FIG. 8 is a depiction of a building management dashboard with a fault notification indicator, which can be generated by the BMSs of FIGS. 4-5, according to some embodiments.

FIG. 9 is a depiction of a fault notification interface, which can be generated by the BMSs of FIGS. 4-5, according to some embodiments.

### DETAILED DESCRIPTION

### Building HVAC Systems and Building Management Systems

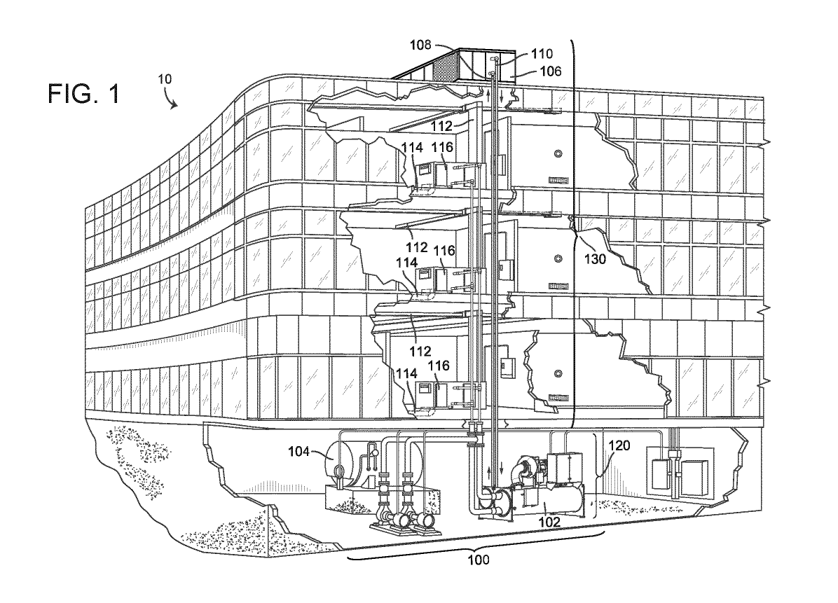

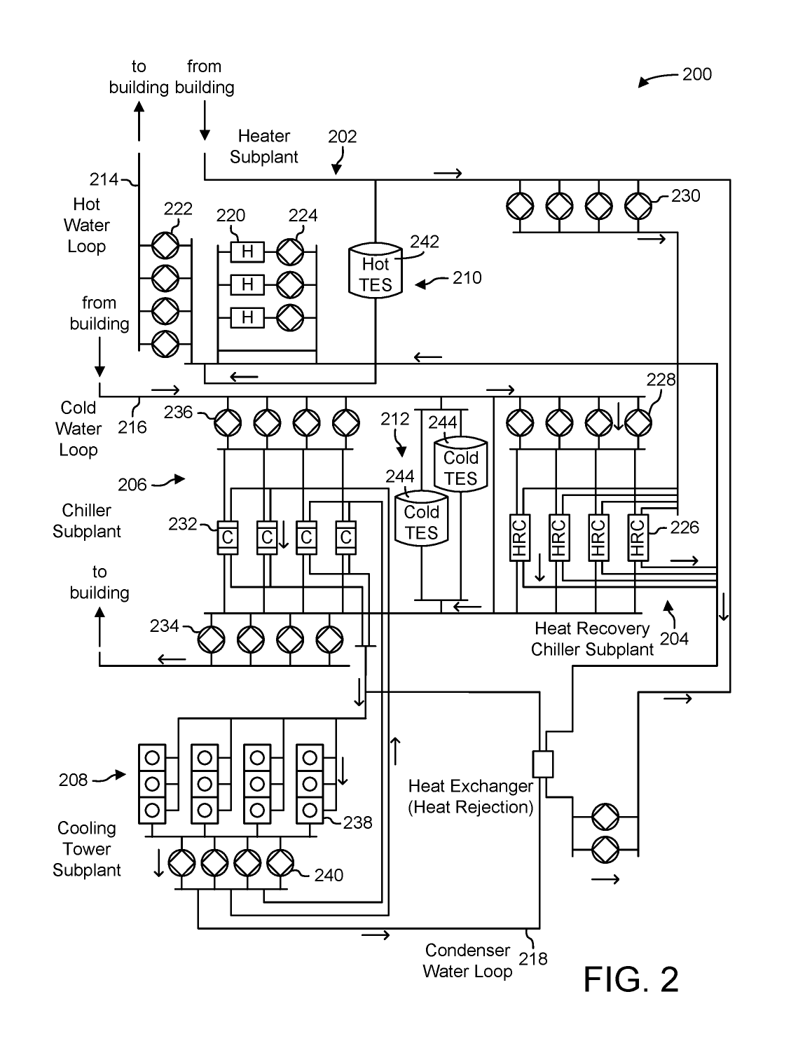

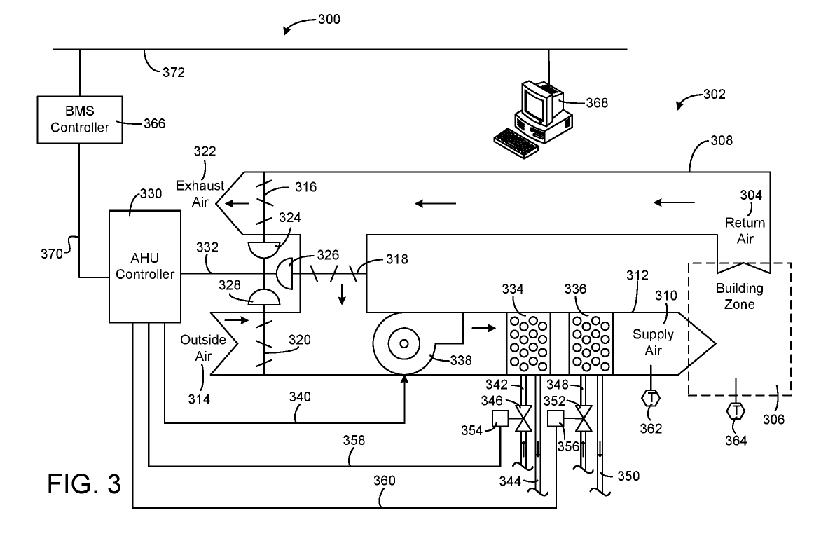

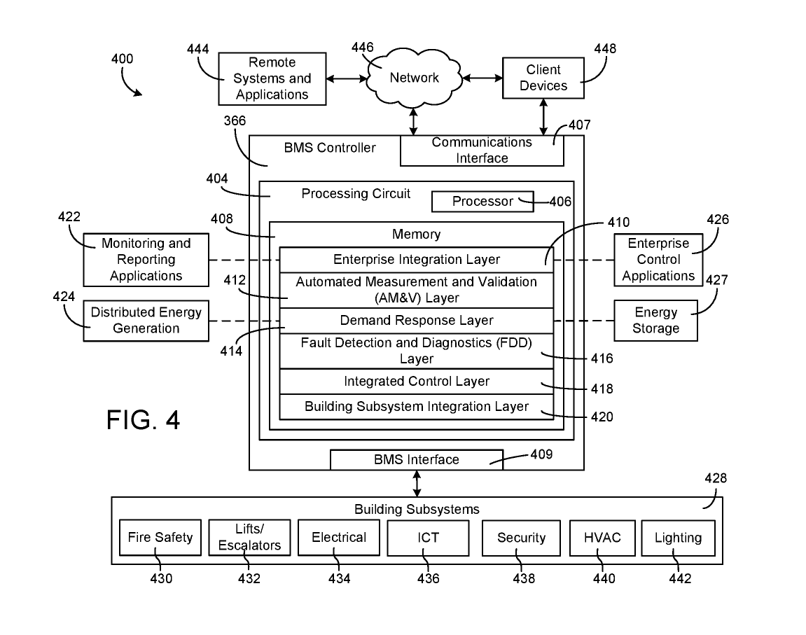

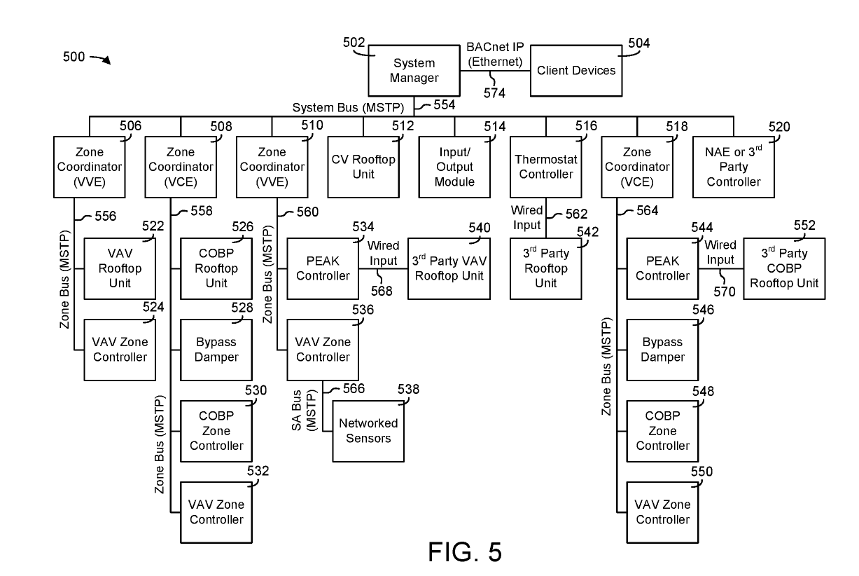

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (TOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Geolocation-Based Fault Notification Center

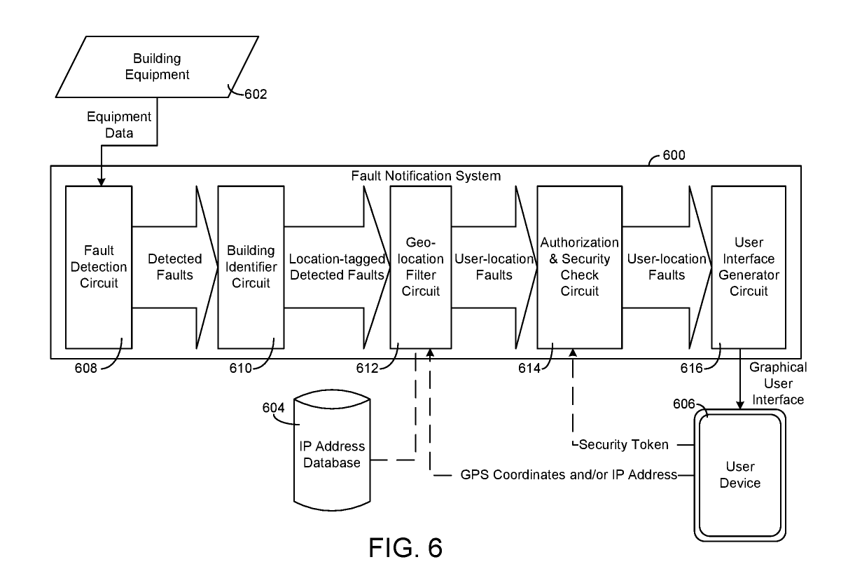

Referring now to FIGS. 6-9, systems and methods for geolocation-based fault notification are shown, according to exemplary embodiments. In a BMS, a fault notification system provides alerts and information to a user related to building equipment which are not functioning as expected, meters which are reporting points outside an expected range, or other data points which indicate some aspect of the BMS is in a fault condition. Traditionally, alerts and reported information may be organized chronologically, such that the most recent faults appear first on a fault notification interface, or may be organized by priority level or criticality. When the BMS components are located in many buildings or facilities distributed in a variety of geographic locations, a user may have difficulty in identifying the faults from the user's current location. An automated system for geolocation-based fault notification as described in detail below may be provided to facilitate the presentation to a user of faults from the user's current location in a BMS.

Referring now to FIG. 6, a geolocation-based fault notification system 600 is shown, according to an exemplary embodiment. In some embodiments, the fault notification system 600 is a component of a BMS, such as BMS 400 or BMS 500 described with reference to FIGS. 4-5. For example, the fault notification system 600 may be included as a component of the system manager 502 of FIG. 5. As shown in FIG. 6, the fault notification system 600 is communicably coupled to building equipment 602 (e.g., HVAC system 100), an IP address database 604, and a user device 606 (e.g., client device 504).

Building equipment 602 is operable to affect a variable state or condition of a building (e.g., temperature, humidity, airflow, lighting) and provide data samples of data points related to the functioning of the building equipment 602. The user device 606 may include a smartphone, tablet, laptop computer, desktop computer, and/or other personal computing device. The user device 606 may include a network interface configured to allow the user device 606 to communicate with the fault notification system 600 via a network, for example the internet, a Wi-Fi network, a cellular network, or some other network. The user device 606 may also include a global positioning system (GPS) chip that detects a location of the user device 606 (e.g., in terms of GPS coordinates). The IP address database 604 stores a look-up table that associates IP addresses with geographic location (e.g., with GPS coordinates). The IP address database 604 may be maintained and operated by an internet service provider.

As shown in FIG. 6, the fault notification system 600 includes a fault detection circuit 608, a building identifier circuit 610, a geolocation filter circuit 612, an authorization and security check circuit 614, and a user interface generator circuit 616. The fault detection circuit 608 receives the equipment data samples from the building equipment 602 and analyzes the data samples to detect faults in the operation of the building equipment 602. Faults may be detected based on a library of fault rules which are applied to the data. Fault rules may be created by a user, provided by the BMS provider, or automatically generated by the BMS, for example as described in “Building Management System with Fault Detection & Diagnostics Visualization,” U.S. patent application Ser. No. 15/821,630 filed Nov. 22, 2017, incorporated by reference herein in its entirety. The fault detection circuit 608 may create an equipment fault data object for each detected fault which includes the name of the equipment in a fault condition and details related to the nature of the fault.

The fault detection circuit 608 may then forward the list of faults or the equipment fault data objects to the building identifier circuit 610. The building identifier circuit 610 may look up the location of each of the faults (i.e., the location of the equipment for which a fault was detected) using the equipment name or other identifier. In some embodiments, the building identifier circuit 610 may store location information in an equipment location database. The building identifier circuit 610 then tags faults with a location indicator, for example by adding a location attribute to an equipment fault object. The building identifier circuit 610 then sends the location-tagged faults to a geolocation-filter circuit 612.

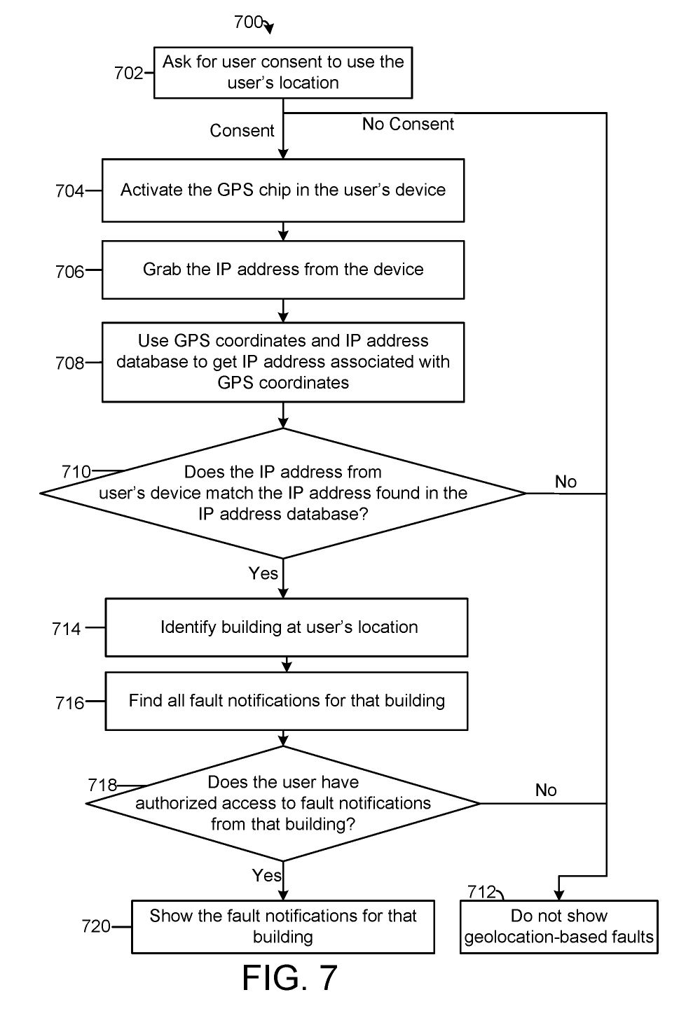

The geolocation filter circuit 612 receives the geolocation-tagged faults from the building identifier circuit 610 and an indication of the user's location from the user device 606 and/or the IP address database 604, and compares the location of the faults to the location of the user. The user's location may be detected using a GPS chip in the user device 606, such as a mobile phone, tablet, or personal computer, for example. The user's location may also be detected by comparing the user's internet protocol (IP) address (i.e., an IP address utilized by the user in accessing the fault notification system 600) to an IP address database 604 provided by internet service providers. In some embodiments, as described in detail with respect to FIG. 7, the user's location may also be detected and verified by using a combination of both a GPS chip and the user's IP address. Using the user's location information, the geolocation filter circuit 612 identifies the building where the user is located from among multiple buildings and/or campuses served by the served by the building equipment 602. For example, the geolocation filter circuit 612 may compare GPS coordinates of a user to stored GPS coordinates associated with each building served by the building equipment 602 and determine whether the GPS coordinates of the user (i.e., of the user device 606) are within a preset distance of the stored GPS coordinates associated with a building.

The geolocation filter circuit 612 then aggregates the faults which are tagged as coming from the building where the user is located, and sends those faults to an authorization and security check circuit 614. The geolocation filter circuit 612 may also prevent all other faults from being presented to the user, or may separate the other faults to be presented to the user separately from the faults from the user's location. Advantageously, the faults from the building where the user is located are prioritized while other faults are hidden or removed, freeing the user from the inefficiencies, confusion, and errors that may be prevalent in other systems that require a user to read through all faults for all locations managed by a BMS in order to become of aware of a fault important to the user.

The authorization and security check circuit 614 then checks whether the user has the authority to view the detected faults for the user's location. The authorization and security check circuit 614 may require the user to input a username and password via the user device 606. The authorization and security check circuit 614 may include a user ID management system, and may check a security token received from the user device 606 against information in the user ID management system. If the authorization and security check circuit 614 determines that the user is authorized to view the detected faults for the user's location, the detected faults for the user's location are sent to the user interface generator circuit 616.

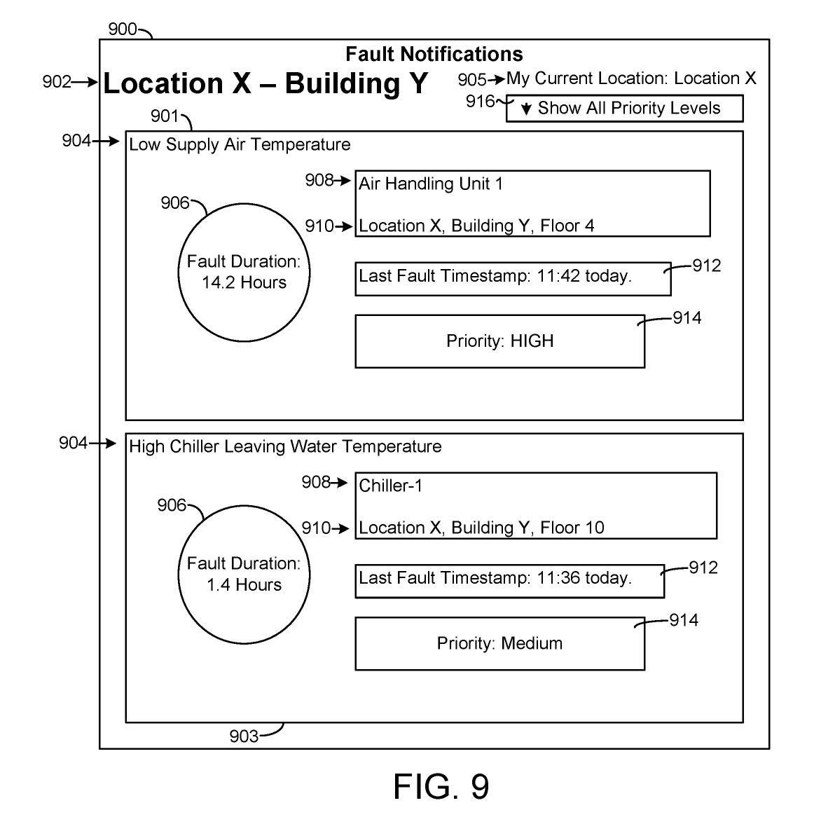

The user interface generator circuit 616 then generates a graphical user interface that presents the detected faults for the user's location to the user. The user interface generator circuit 616 may sort the detected faults for the user's location based on equipment type, commodity type, sub-location, severity, criticality, or chronology (e.g., most recent first, longest-lasting first), or any other organization and present the faults in a list or some other format. The user interface generator circuit 616 may also access other fault information stored in the fault object and populate the user interface with the information. This information may include a fault type, a fault name, an equipment type, an equipment device name, an equipment location, a fault duration, a fault priority, raw data samples related to the fault, and fault timing data. An example of such a graphical user interface is shown in FIG. 9 and described in detail with reference thereto. The user interface generator circuit 616 provides the user interface to the user device 606. The user is thereby presented with an interface that displays faults from the user's location and other fault information for those faults, while faults from other locations may be prevented from being shown to the user.

In some embodiments, the user interface generated by the user interface generator circuit 616 may also present detected faults for locations other than the user's location. The detected faults for other locations may be listed after the detected faults for the user's location on the user interface. In some embodiments, the list is automatically sorted to show the faults for the building in which the user is located at the top of the list. In some embodiments, the detected faults may be accessed by selecting an indicator for another location or locations on the user interface or by using a drop-down menu. A clear indication of the fault's location may be presented to facilitate easy navigation of the fault notifications. The authorization and security check circuit 614 may require a separate authorization and security check before allowing the user to view faults from another location.

Referring now to FIG. 7, a flowchart of a process 700 for presenting fault notifications based on a user's location is shown, according to an exemplary embodiment. In some embodiments, the process 700 is performed by the geolocation-based fault notification system 600 of FIG. 6.

At step 702, the fault notification system 600 asks a user for consent to use the user's location, for example by generating a prompt for display on the user device 606. If consent is not received, the user will be prevented from using the geolocation-based fault notification system. If user consent is received (e.g., via the user device 606), at step 704 a GPS chip in the user device 606 (e.g., personal computer, mobile phone, tablet) is activated, and, at step 706 the GPS coordinates of the user's device are collected by the fault notification system 600. The IP address of the user device 606 may also be collected from the user device 606 by the fault notification system 600.

At step 708, the fault notification system 600 accesses an IP address database 604 provided by one or more internet service providers and look up IP addresses associated with the GPS coordinates of the user's device. Then, at step 710, the fault notification system 600 checks whether the IP address collected from the user's device matches an IP address associated with the user's GPS coordinates in the IP address database. The fault notification system 600 may thereby combine two modalities of determining the user's location to verify the user's location. If the user's GPS coordinates do not match an IP address for that location, the fault notification system 600 may determine a security risk and prevent the user device from accessing fault notifications in the fault notification system 600 at step 712.

If the user's GPS coordinates do match an IP address for the user's location, at step 714 the user's location (e.g., the user's GPS coordinates) is then associated with the building or facility at which the user is located and which is served by the BMS (e.g., BMS 500) and the building equipment 602. The building or facility may be selected from a list of buildings or facilities served by the BMS. In some embodiments, if the user's location is not in a building or facility served by the BMS, the fault notification system 600 may associate the user with the nearest building or facility served by the BMS or may prevent the user from accessing the geolocation-based fault system.

If the user's location is matched to a building or facility served by the BMS, at step 716 all fault notifications for that building or facility are found and aggregated by the fault notification system 600. At step 718, the fault notification system 600 then determines whether the user has authorized access to view the faults for that building or facility. For example, the fault notification system 600 may check a security token from the user device 606 with an ID management system that stores user authorizations. If the user is determined to not have authorized access to the faults, the user is prevented from accessing the geolocation-based fault system and no faults are shown at step 712.

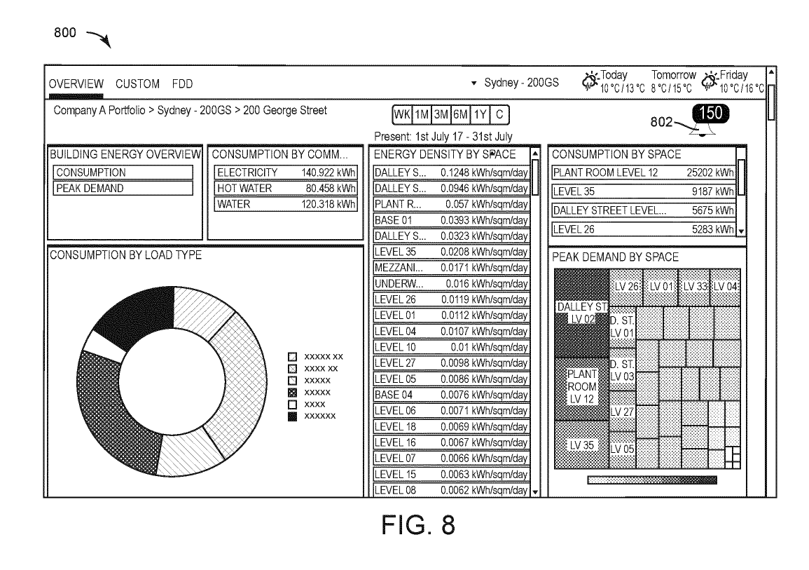

If the user is determined to have authorized access to view the faults, at step 720 the fault notifications are provided to the user, for example via a graphical user interface generated by the fault notification system 600 and provided to the user device 606. An example of such user interfaces are shown in FIGS. 8-9 and described in detail below.

Referring now to FIG. 8, a building management dashboard 800 with a fault notification indicator 802 is shown, according to an exemplary embodiment. In some embodiments, the building management dashboard 800 is generated by BMS 400 or BMS 500, as described with reference to FIGS. 4-5 (e.g., by the system manger 502). The building management dashboard 800 may include multiple widgets that show key performance indicators for the buildings or facilities and/or building equipment served by the BMS (e.g., building equipment 602). The building management dashboard 800 may be limited to show key performance indicators for the user's location only, or may show information related to all facilities in the BMS. The building management dashboard 800 includes a fault notification indicator 802, located in the upper right corner in the example of FIG. 8. The fault notification indicator 802 may be configured to change colors when a fault occurs and may display the number of current faults or the number of new fault notifications. An audible alarm may also be provided to indicate a new fault notification. In some embodiments, the fault notifications indicated by the fault notification indicator 802 may include fault notifications only for detected faults from the user's location. The fault notification indicator 802 may be selected by the user to access a fault notification interface, for example as shown in FIG. 9.

Referring now to FIG. 9, a fault notification interface 900 is shown, according to an exemplary embodiment. In various embodiments, the fault notification interface 900 is generated by the fault notification system 600 of FIG. 6 and/or BMS 400 or BMS 500 of FIGS. 4-5. The fault notification interface 900 may display the name 902 of the building or facility of the user's location, i.e., the location for which faults are shown (shown as “Location X-Building Y”). In some embodiments, the fault notification interface 900 includes a location indictor 905 that states the location of the user. The fault notification interface 900 may also present information related to each fault from the user's location, shown as first fault 901 and second fault 903. The information for each fault 901, 903 may include a fault description 904, a fault duration 906, the name 908 of the equipment in a fault condition, the name 910 of the space where the fault is located, the latest timestamp 912 of the fault, and a fault priority level 914. The fault notification interface may also include other relevant information about the faults. The fault notification interface may also include a priority level drop-down menu 916 which allows a user to select to only view faults of a selected priority level (e.g., high priority, low priority). The fault notification interface 900 may thereby provide the user with information about the most relevant faults to the user.

In some embodiments, the fault notification interface 900 includes one or more options to input a command relating to the building equipment. For example, the fault notification interface 900 may allow a user to input a command to turn off a unit of building equipment in a fault condition, turn on backup equipment, and/or adjust various settings of the building equipment to address a detected fault. The user interface generation circuit 616 may receive a command input by a user via the fault notification interface 900 and provide the command to the system manager 502. The system manager 502 may then control the building equipment as commanded by the user. In some embodiments, because the faults provided to the user on the fault notification interface 900 may be limited to those within a geolocational proximity to the user (e.g., within a particular building), the building equipment controllable by the system manager 502 in response to a user command may also be limited to that geolocational area. Advantageously, the user may thereby be prevented from affecting the operation of building equipment not located proximate to the user.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building management system comprising:
building equipment located in a plurality of locations and configured to provide data relating to operation of the building equipment; and
a fault notification system configured to:
collect the data from the building equipment;
detect a fault in the operation of the building equipment based on the data;
identify a fault location of the fault from the plurality of locations;
identify a user location of the user from the plurality of locations;
determine whether the user location matches the fault location; and
in response to a determination that the user location matches the fault location, provide a graphical user interface to a user;
wherein the graphical user interface provides information relating to the fault.

2. The building management system of claim 1, wherein the fault notification system is configured to prevent the user from accessing information about the fault in response to a determination that the user location does not match the fault location.

3. The building management system of claim 1, wherein the fault notification system is configured to verify the user location by:
receiving GPS coordinates of a user device from the user device;
receiving an IP address of the user device;
accessing a look-up table that associates a set of IP addresses with the GPS coordinates of the user device; and
determining whether the IP address of the user device is included in the set of IP addresses with the GPS coordinates of the user device.

4. The building management system of claim 1, wherein the fault notification system is configured to determine whether the user is authorized to access fault notifications for the fault location.

5. The building management system of claim 1, wherein the fault notification system is configured to generate a fault data object for the detected fault and include the fault location as an attribute of the fault data object.

6. The building management system of claim 1, wherein:
the plurality of locations comprises a plurality of buildings; and
the fault notification system is configured to identify the user location of the user from the plurality of locations by:
receiving GPS coordinates of a user device from the user device; and
determining that the GPS coordinates of the user device are within a first building of the plurality of buildings.

7. The building management system of claim 6, wherein the fault notification system is configured to:
receive consent from the user to use a location of the user device; and
cause a GPS chip of the user device to activate and provide the GPS coordinates to the fault notification system in response to receiving the consent from the user.

8. A method for managing and controlling building equipment, comprising:
operating building equipment to provide data relating to operation of the building equipment, the building equipment located in a plurality of locations;
detecting a fault in the operation of the building equipment based on the data;
identifying a fault location of the fault from the plurality of locations;
identifying a user location of the user from the plurality of locations;
determining whether the user location matches the fault location; and
in response to a determination that the user location matches the fault location, providing a graphical user interface to a user;
wherein the graphical user interface provides information relating to the fault.

9. The method of claim 8, further comprising preventing the user from accessing information about the fault in response to a determination that the user location does not match the fault location.

10. The method of claim 8, further comprising verifying the user location by:
receiving GPS coordinates of a user device from the user device;
receiving an IP address of the user device;
accessing a look-up table that associates a set of IP addresses with the GPS coordinates of the user device; and
determining whether the IP address of the user device is included in the set of IP addresses with the GPS coordinates of the user device.

11. The method of claim 8, comprising determining whether the user is authorized to access fault notifications for the fault location.

12. The method of claim 8, comprising generating a fault data object for the detected fault and including the fault location as an attribute of the fault data object.

13. The method of claim 8, wherein identifying a user location of the user from the plurality of locations comprises:
receiving GPS coordinates of a user device from the user device;
determining that the GPS coordinates of the user device are within a present distance of the GPS coordinates of a first location of the plurality of locations.

14. The method of claim 13, further comprising:
receiving consent from the user to use the location of the user device; and
causing a GPS chip of the user device to activate and provide the GPS coordinates in response to receiving the consent from the user.

15. A building management system comprising:
building equipment located in a plurality of locations and configured to provide data relating to operation of the building equipment; and
a fault notification system configured to:
collect the data from the building equipment;
detect a plurality of faults in the operation of the building equipment based on the data;
identify, for each of the plurality of faults, a fault location from the plurality of locations;
identify a user location of a user device from the plurality of locations by causing a GPS chip of the user device to activate and provide the user location to the fault notification circuit;
identify a set of faults from the plurality of faults for which the fault location matches the user location;
generate a graphical user interface that identifies each fault of the set of faults; and
provide the graphical user interface to the user device.

16. The building management system of claim 15, wherein the graphical user interface comprises a list of the faults from the set of faults, the list organized based on a priority of each fault.

17. The building management system of claim 15, wherein the graphical user interface includes a list of each of the plurality of faults, the set of faults for which the user location matches the fault location positioned at a top of the list.

18. The building management system of claim 15, wherein:
the plurality of locations comprises a plurality of buildings; and
the building equipment is operable affect variable states or conditions of the plurality of buildings.

19. The building management system of claim 17, wherein the building equipment comprises HVAC equipment.

20. The building management system of claim 15, wherein the fault notification system is configured to:
receive a security token from the user device; and
in response to receiving the security token, allow the user to access the graphical user interface.
